(19) United States
(12) Patent Application Publication
(10) Pub. No.: US 2025/0241476 A1
(43) Pub. Date: Jul. 31, 2025

(54) CANISTER SYSTEM FOR BUBBLE TEA MACHINE

(71) Applicant: Dongguan ZEEWAY-Technology Ltd, Guangdong Province (CN)

(72) Inventors: Mengyi Zhu, Guangdong Province (CN); Liang Zhou, Guangdong Province (CN)

(73) Assignee: Dongguan ZEEWAY-Technology Ltd, Guangdong Province (CN)

(21) Appl. No.: 18/955,961

(22) Filed: Nov. 21, 2024

(30) Foreign Application Priority Data
Jan. 26, 2024 (CN) 2024202081089

(51) Int. Cl. A47J 31/44

(52) U.S. Cl. CPC A47J 31/4403

(57) ABSTRACT

The present disclosure discloses a canister system for a bubble tea machine. It comprises a rack, at least one canister, an ingredient storage box, and a pipeline system. The rack is provided with a refrigeration chamber. The canister is stored in the refrigeration chamber. The pipeline system makes the canister communicate with the ingredient storage box. The canister includes a canister body, a canister cover, and a feeding pipeline structure. The feeding pipeline structure is installed on the canister cover. The canister cover is installed on the canister body. The feeding pipeline structure is communicated with the pipeline system. The above canister system for a bubble tea machine can extend to the bottom of the canister body through the feeding pipeline structure, so that all ingredients in the canister body can be fed, avoiding ingredient residue to the bottom of the canister body, avoiding waste, and thereby reducing production costs.

### TECHNICAL FIELD

The present disclosure relates to technical field of bubble tea machines, in particular, to a canister system for a bubble tea machine.

### BACKGROUND

With improvement of living standards, leisure drinks are essential in people's lives, and a bubble tea beverage series is the most popular among the public.

Production of traditional bubble tea is usually done manually, and there is currently no machine that can achieve automatic production of bubble tea. Manually on-site dispensing and stirring ingredients is not only time-consuming and extremely inefficient, but also prone to make wrong in manual ratio, resulting in different or inconsistent taste for the bubble tea made according to the same recipe each time. In addition, the labor intensity of employees is high.

A Chinese patent (CN 202121698829.5) discloses a dispensing ingredient system for beverage machines to solve above technical problems, comprising: at least one ventilation device, a canister, and a mixing device. A stirring component and a pushing component are equipped in each canister. The pushing component is rotatably connected to the stirring component. The stirring component is used to stir ingredients in the canister and the pushing component is used to push the ingredients in the canister into the mixing device. The mixing device is used to mix ingredients with liquid, and the ventilation device is used to extract water vapor from the mixing device. However, the above-mentioned canister dispensing ingredients from bottom, which cannot completely dispense the ingredients in the canister. There will be residual ingredients at the bottom of the canister, resulting in waste, or there is a need to disassemble the entire canister from the bubble tea machine. This method is time-consuming and labor-intensive, affecting efficiency of bubble tea preparation.

### SUMMARY

A main purpose of the present disclosure is to provide a canister system for a bubble tea machine to solve the above technical problems, which can completely feed ingredients without remaining at bottom of a canister.

To achieve the above purpose, the present disclosure adopts following technical solutions:
a canister system for a bubble tea machine, comprising a rack, at least one canister, an ingredient storage box, and a pipeline system, wherein a refrigeration chamber is provided in the rack, the canister is stored in the refrigeration chamber, and the canister is communicated with the ingredient storage box through the pipeline system, and wherein the canister comprises a canister body, a canister cover which is installed on the canister body, and a feeding pipeline which is installed on the canister cover and is communicated with the pipeline system.

As a preferred technical solution, the feeding pipeline comprises a silicone sleeve which is installed on the canister cover, a feeding pipe which is installed at the lower end of the silicone sleeve and extends to the bottom of the canister body, and a quick connector which is installed on the silicone sleeve, and through which the pipeline system is communicated with the silicone sleeve.

As a preferred technical solution, the lower end of the canister body is funnel-shaped.

As a preferred technical solution, the lower end of the canister body is provided with a

discharge port, and the canister further comprises an end cover, which is screwed at the discharge port.

As a preferred technical solution, the canister body further comprises a handle, which is installed on a side of the canister body.

As a preferred technical solution, the canister cover is provided with a canister door, and the canister door is hinged with the canister cover.

A beneficial effect of the present disclosure is in that the above canister system for a bubble tea machine can be extended to the bottom of the canister body through the feeding pipeline, so that all ingredients in the canister body can be fed, without ingredient remaining at the bottom of the canister body, avoiding waste, and thereby reducing production costs.

### BRIEF DESCRIPTION OF FIGURES

FIG. 1 is a schematic diagram of a canister system for a bubble tea machine according to the present disclosure;

FIG. 2 is a schematic diagram of a canister involved in the present disclosure.

### DETAILED DESCRIPTION

In order to make purposes, technical solutions, and advantages of the present disclosure clearer and more understandable, the following will provide further detailed explanations of the present disclosure in conjunction with the accompanying drawings and embodiments. It should be understood that the specific embodiments described here are only used to explain the present disclosure and are not intended to limit the present disclosure.

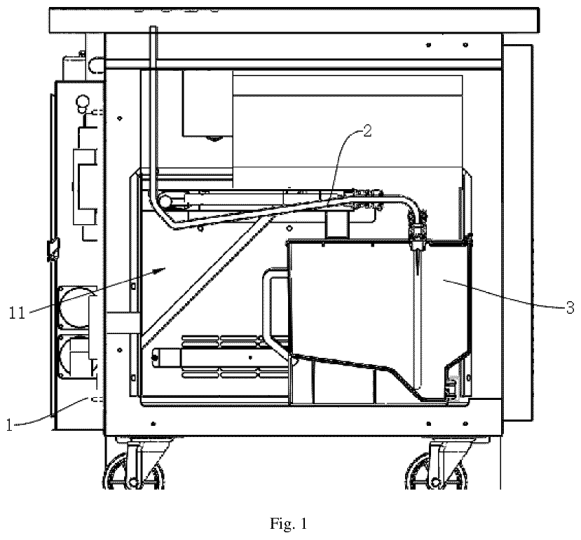

As shown in FIG. 1, the canister system for the bubble tea machine comprises a rack 1, at least one canister 3, an ingredient storage box (not shown in the figure) and a pipeline system 2. A refrigeration chamber 11 is provided in the rack 1. The canister 3 is stored in the refrigeration chamber 11 to cool and store ingredients, avoided exposure to room temperature, at which are prone to be spoilage. The ingredient storage boxes are provided corresponding to the canisters 3. The ingredient storage boxes are placed on upper surface of the rack 1 to improve equipment space efficiency. The canister 3 is communicated with the ingredient storage box through the pipeline system 2. When there is a shortage of ingredients in one of the ingredient storage boxes, the pipeline system 2 is activated to form negative pressure, and the ingredients in the corresponding canister 3 is fed into the ingredient storage box, which is convenient for the operator to refill the ingredient storage box. The pipeline system 2 is provided with an integrated cleaning water circuit to save equipment space.

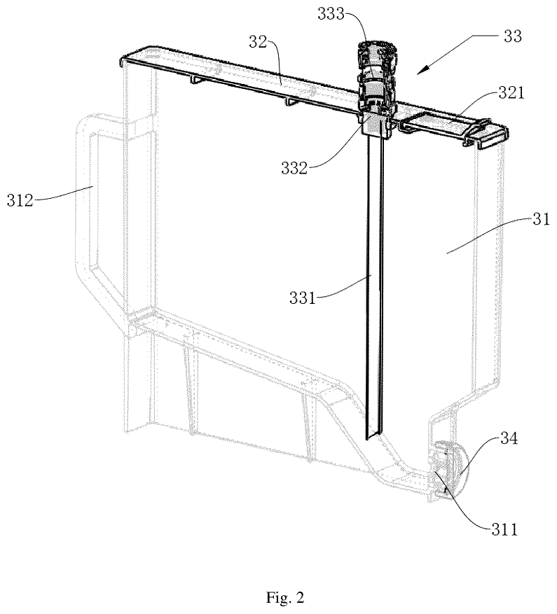

As shown in FIG. 2, the canister 3 includes a canister body 31, a canister cover 32, a feeding pipeline 33, and an end cover 34. The feeding pipeline 33 is installed on the canister cover 32. The canister cover 32 is installed on the canister body 31. The feeding pipeline 33 is communicated with the pipeline system 2, so that the pipeline system 2 can adsorb and feed the ingredients stored in the canister body 31 through the feeding pipeline 33. The lower end of the canister body 31 is provided with a discharge port 311, and the end cover 34 is screwed at the discharge port 311 to facilitate pouring out of the ingredient in the canister body 31. The feeding pipeline 33 includes a silicone sleeve 332, a feeding pipe 331, and a quick connector 333. The silicone sleeve 332 is installed on the canister cover 32. The feeding pipe 331 is installed at the lower end of the silicone sleeve 332 and extends to the bottom of the canister body 31, allowing for direct feeding from the bottom of the canister body 31 through the feeding pipe 331, and avoiding ingredient residue at the bottom of the canister body 31. The quick connector 333 is installed on the silicone sleeve 332. The silicone sleeve 332 can prevent ingredient from leaking between the silicone sleeve 332 and the canister cover 32. The pipeline system 2 is communicated with the silicone sleeve 332 through the quick connector 333. Quickly assembling the canister 3 with the pipeline system 2 can be realized through the quick connector 333. The lower end of the canister body 31 is funnel-shaped, which can concentrate all the ingredient in the canister body 31. The canister body 31 also includes a handle 312, which is installed on the side of the canister body 31 for easy handling of the canister body 31. The canister cover 32 is provided with a canister door 321, and the canister door 321 is hinged with the canister cover 32.

The above mentioned embodiments are only better examples of the present disclosure, not to limit the scope of the present disclosure. Therefore, any equivalent changes or modifications made in accordance with the structure, features and principles described in the scope of the present disclosure should be included in the scope of the present disclosure.

What is claimed is:

1. A canister system for a bubble tea machine, comprising a rack, at least one canister, an ingredient storage box, and a pipeline system, wherein a refrigeration chamber is provided in the rack, the canister is stored in the refrigeration chamber, and the canister is communicated with the ingredient storage box through the pipeline system, and wherein the canister comprises a canister body, a canister cover which is installed on the canister body, and a feeding pipeline which is installed on the canister cover and is communicated with the pipeline system.

2. The canister system for a bubble tea machine of claim 1, wherein the feeding pipeline comprises a silicone sleeve which is installed on the canister cover, a feeding pipe which is installed at the lower end of the silicone sleeve and extends to the bottom of the canister body, and a quick connector which is installed on the silicone sleeve, and through which the pipeline system is communicated with the silicone sleeve.

3. The canister system for a bubble tea machine of claim 2, wherein the lower end of the canister body is funnel-shaped.

4. The canister system for a bubble tea machine of claim 3, wherein the lower end of the canister body is provided with a discharge port, and the canister further includes an end cover, which is screwed at the discharge port.

5. The canister system for a bubble tea machine of claim 3, wherein the canister body further comprises a handle, which is installed on the side of the canister body.

6. The canister system for a bubble tea machine of claim 5, wherein the canister cover is provided with a canister door which is hinged with the canister cover.
